(19) United States
(12) Patent Application Publication
(10) Pub. No.: US 2025/0309705 A1
(43) Pub. Date: Oct. 2, 2025

(54) ELECTRIC POWER GENERATION USING PLANAR ARRAY OF FERRITE CORES

(71) Applicant: Cisco Technology, Inc., San Jose, CA (US)

(72) Inventors: Joel Richard Goergen, Soulsbyville, CA (US); Kameron Rose Hurst, Sonora, CA (US); Alpesh Umakant Bhobe, Sunnyvale, CA (US); David Nozadze, San Jose, CA (US); Elizabeth Kochuparambil, Morgan Hill, CA (US); Jenjen Tiao, Allentown, PA (US)

(21) Appl. No.: 18/618,009

(22) Filed: Mar. 27, 2024

(51) Int. Cl. H02K 1/12; H02K 1/02; H02K 3/04

(52) U.S. Cl. CPC H02K 1/12; H02K 3/04; H02K 1/02

(57) ABSTRACT

An apparatus configured to generate electric power. The apparatus includes a base plate, a plurality of ferrite cores arranged on the base plate in a geometric pattern, each ferrite core in the plurality of ferrite cores having a longitudinal axis that is normal to the base plate, at least one coil wound around each ferrite core in the plurality of ferrite cores, and an array of magnets arranged to pass over exposed end faces of each ferrite core in the plurality of ferrite cores.

### TECHNICAL FIELD

The present disclosure relates to electric power generation using an array of coil-wrapped ferrite cores mounted on a ferrite base plate.

### BACKGROUND

Generators are based on the principle of electromagnetic induction. Specifically, when an electrical conducting material (such as copper) is moved through a magnetic field (or vice versa), electric current flows through the material.

Power generation devices include rotary generators and linear alternators. Typically, rotary generators employ large quantities of wire loops or coils spinning around the inside of very large magnets. In this situation, the coils of wire are called the “armature” because they are moving with respect to the stationary magnets (which, collectively, are referred to as the “stator”). Linear alternators, in contrast, usually have a magnetic core moving through coils of wire. As the magnetic core passes through the coils, electric current is generated.

In practice, an outside energy source is used to provide power to move the armature with respect to the stator. Such sources might be mechanical power from a reciprocating or turbine steam engine, water falling through a turbine or waterwheel, an internal combustion engine, or a wind turbine, among other possibilities.

### BRIEF DESCRIPTION OF THE DRAWINGS

FIG. 1 shows components of a stator of an electric power generator, according to an example embodiment.

FIG. 2 shows an array of ferrite cores mounted on a ferrite base plate along with an array of magnets that is configured to pass over exposed ends of the ferrite cores, according to an example embodiment.

FIG. 3 shows a circuit for regulating electric power that is generated by the electric power generator, according to an example embodiment.

FIG. 4 shows an implementation in which generated electric energy is regulated, stored, and then made available to follow up systems, such as a fault managed power system, according to an example embodiment.

FIG. 5A shows the electric power generator operating in conjunction with a vehicle, according to an example embodiment.

FIG. 5B shows the use of a ferrite shield to direct a magnetic field toward the stator, according to an example embodiment.

FIG. 6 shows an electric power generator with a circular stator operating in conjunction with a water wheel, according to an example embodiment.

FIG. 7 shows an electric power generator operating in conjunction with a wave power source, according to an example embodiment.

FIG. 8 is a flow chart showing a series of operation for generating power with the electric power generator, according to an example embodiment.

FIG. 9 is a block diagram of a computing device that may be configured to operate and/or control fault managed power, and perform the techniques described herein, according to an example embodiment.

### DETAILED DESCRIPTION

### Overview

An apparatus is configured to generate electric power. The apparatus includes a base plate, a plurality of ferrite cores arranged on the base plate in a geometric pattern, each ferrite core in the plurality of ferrite cores having a longitudinal axis that is normal to the base plate, at least one coil wound around each ferrite core in the plurality of ferrite cores, and an array of magnets arranged to pass over exposed end faces of each ferrite core in the plurality of ferrite cores.

In another embodiment, a device is provided. The device includes a ferrous base plate, ferrite cores arranged on the ferrous base plate, the ferrite cores having a longitudinal axis that is normal to the ferrous base plate, the ferrite cores having respective exposed end faces, at least one coil respectively wound around the ferrite cores, and an array of magnets arranged to pass over the exposed end faces.

In still another embodiment, a method is provided. The method includes moving a magnet across exposed end surfaces of ferrite cores arranged in an array, wherein each ferrite core among the ferrite cores has a coil wrapped therearound, generating a changing magnetic flux gradient in the ferrite cores responsive to the magnet moving across the exposed end surfaces of the ferrite cores, capturing electrical power induced in each coil by the changing magnetic flux gradient, and distributing the electrical power to a load.

### Example Embodiments

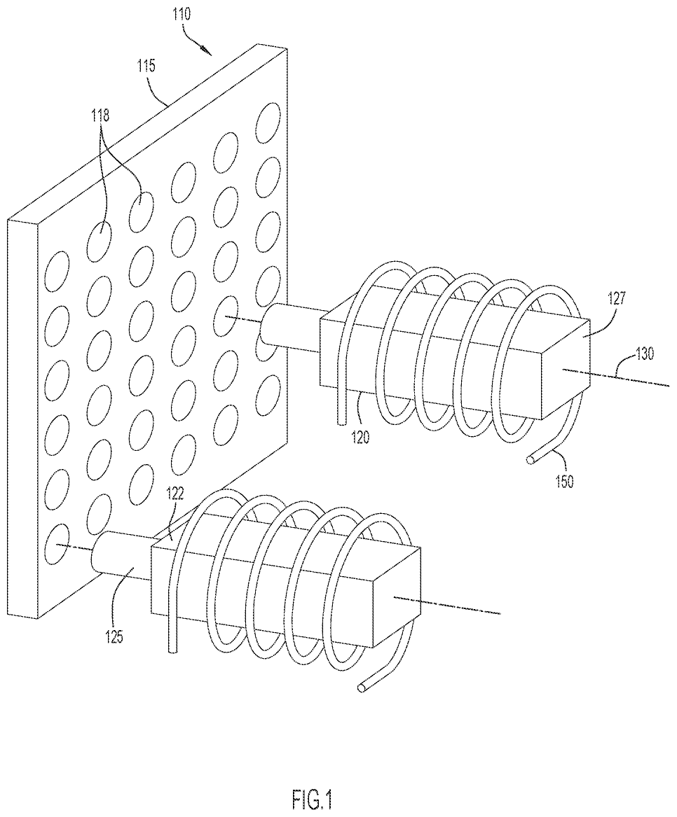

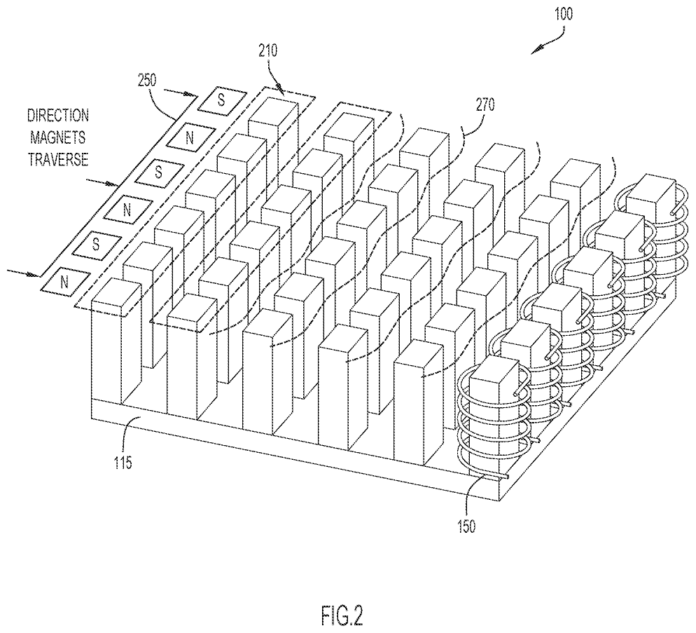

FIG. 1 shows components of a stator 110 of an electric power generator 100 (FIG. 2), according to an example embodiment. Stator 110 includes a base plate 115, made of a ferrous material, including, in one embodiment, a plurality of holes or cutouts 118, which may be rounded or squared. Ferrite cores 120, each having a substantially square cross-sectional shape, are configured to be mounted to base plate 115. In one embodiment, the ferrite cores 120 have a longitudinal axis 130, such that when the ferrite cores 120 are mounted to the base plate 115, the longitudinal axis 130 is normal to the base plate 115. In one mounting approach, a mounting end 122 of each ferrite core 120 includes a protrusion 125 that is configured to mate with a corresponding opening or cutout 118. Each ferrite core 120 also includes an exposed face 127. A coil 150 is wrapped around each ferrite core 120. Multiple coils 150 may also be wrapped around each ferrite core 120 in an overlapping fashion and connected in series or in parallel with one another. In one possible embodiment, each ferrite core 120 is one inch by one inch, and six inches long. In this embodiment, the exposed face 127 may be, e.g., one inch square. Base plate 115 may be, in one implementation, 12 inches by 12 inches.

Those skilled in the art will appreciate that other dimensions of the aforesaid components may be different. Base plate 115 and ferrite cores 120 could also be machined from a single piece of ferro-magnetic material.

FIG. 2 shows electric power generator 100 including an array 210 of ferrite cores 120 mounted on base plate 115 along with an array of magnets 250 that is configured to pass over exposed faces 127 of the ferrite cores 120, according to an example embodiment. In the embodiment shown, array 210 of ferrite cores 120 comprises six rows and six columns with six ferrite cores 120 in each row, for a total of 36 ferrite cores 120. In the figure, only the row to the right has coils 150 illustrated, but it should be understood that each of the ferrite cores 120 would be wrapped with its own coil 150, or multiple coils.

In the embodiment illustrated, array of magnets 250 includes six magnets that are configured in a row and are spaced substantially similarly to the exposed faces 127 of the ferrite cores. The array of magnets 250 may be mounted to, e.g., a plastic, or other non-magnetic material, mount to maintain its linear configuration. Array of magnets 250 may also include multiple rows of magnets. The individual magnets in the array of magnets 250 are positioned with alternating poles facing the exposed faces 127 of the ferrite cores 120. The poles of the magnets could also be configured to all be in the same direction. As the array of magnets 250 passes over exposed faces 127 of the ferrite cores 120, a dynamic and changing magnetic flux gradient 270 spreads out among the ferrite cores 120 since they are all connected to one another via base plate 115. The generated and changing magnetic flux, as the array of magnets 250 transits over the exposed faces 127 of the ferrite cores, causes electric current to flow in each of the coils 150.

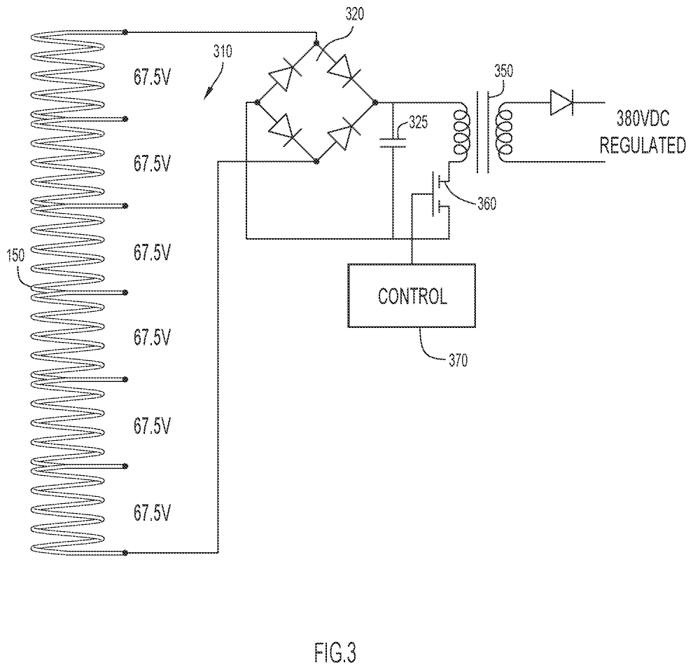

FIG. 3 shows a circuit for regulating electric power that is generated by the electric power generator 100, according to an example embodiment. In an experiment, 240 turns on a coil 150 generated 6.75 volts, using a one-inch cube neodymium magnets each generating a magnetic field of approximately 1000 Gauss. With 2400 turns, each coil 150 may then generate 67.5 volts, and six such coils connected in series would generate 405 VAC. An output 310 the series-connected coils 150 is applied to a full bridge rectifier 320, an output of which is filtered by a capacitor 325, and passed through a primary coil of an isolation transformer 350 that is switched via switch 360, to achieve desired regulation. Switch 360 may be controlled by a control circuit 370, which operates with appropriate feedback (not shown). A secondary coil of the isolation transformer 350 may be passed through a rectifier to supply, e.g., 380 VDC regulated power.

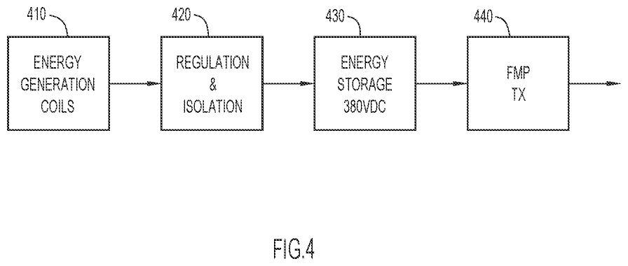

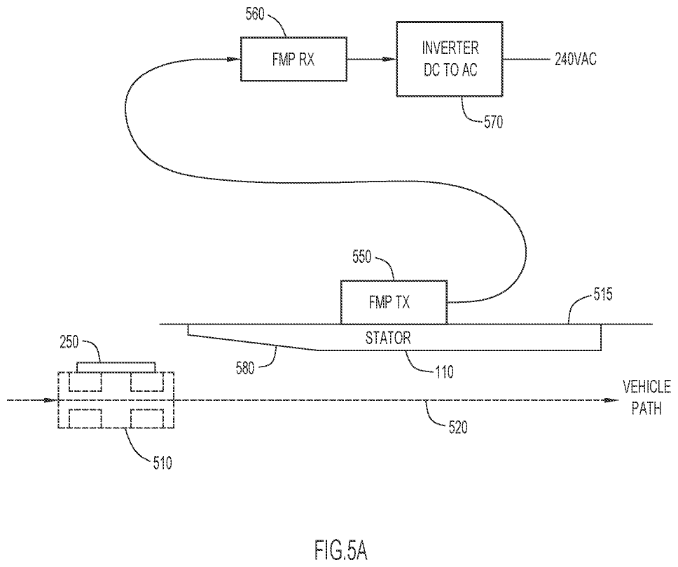

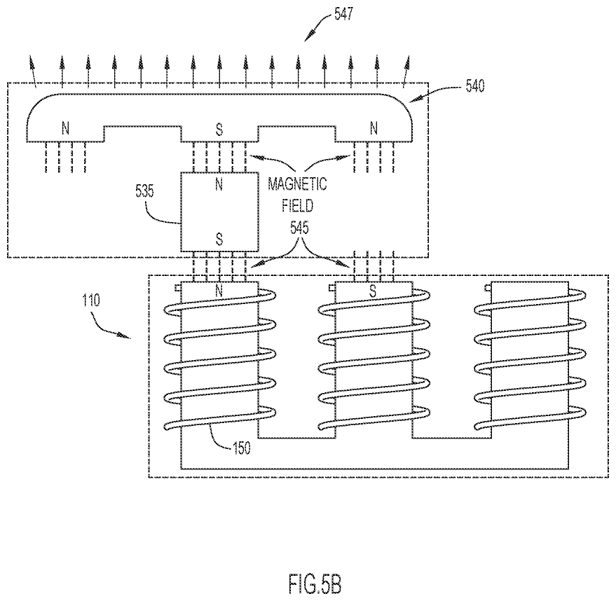

FIG. 4 shows a block diagram circuit implementation in which generated electric energy is regulated, stored, and then made available to follow on systems, such as a fault managed power system, according to an example embodiment. More specifically, energy generation coils 410, such as coils 150 wrapped around ferrite cores 120 that are attached to base plate 115, generate electricity when the array of magnets 250 is passed over the exposed faces 127 of the ferrite cores 120. The generated and raw electric energy is supplied to a regulation and isolation circuit 420, such as that shown, e.g., in FIG. 3. The resulting regulated electric power, e.g., at 380 VDC, may be stored in an energy storage device 430, e.g., a storage capacitor. The stored energy may then be supplied directly to a load, and/or distributed to a remote location (and load) using, e.g., a fault managed power (FMP) transmitter 440 (discussed below in connection with FIG. 5A), or other distribution technique.

FIG. 5A shows the electric power generator 100 operating in conjunction with a vehicle 510, according to an example embodiment. As noted, to generate electricity with the electric power generator 100, the array of magnets 250 is passed over the exposed faces 127 of the ferrite cores 120. One possible way to achieve movement of the array of magnets 250 is to arrange the base plate 115 and ferrite cores 120 (the stator 110) along the side of a road, e.g., attached to a guardrail 515, or perhaps embedded in the road (not shown). The array of magnets 250 could be affixed to vehicle 510, which travels along vehicle path 520 next to the guardrail 515 with mounted stator 110. Stator 110 may include a ramped section 580 (where the height of the ferrite cores 120 is increased to a full height over a predetermined distance) to prevent immediate magnetic attraction between the array of magnets 250 and ferrite cores 120. In one embodiment, the ramped section could be on the order of 20 feet, and the remaining part of the stator 110 could be on the order of 300 feet.

In an embodiment, vehicle 510 may be a self-driving vehicle that can maintain a steady and close distance (e.g., two inches) between the exposed faces 127 of the ferrite cores 120 and faces of magnets in the array of magnets 250 mounted to the vehicle 510. If there is sufficient room, additional rows of ferrite cores 120 can be added to the stator 110, especially in the case where there may be tens of feet of guardrail 515, as in the example of FIG. 5A. For example, there could tens of or even hundreds of feet of guardrail 515 that could be available for mounting of stator 110.

FIG. 5B shows the use of a ferrite shield to direct a magnetic field toward the stator, according to an example embodiment. That is, in this, and other embodiments, a ferrite shield 540 may be disposed between a magnet 535 and, e.g., vehicle 510. Ferrite shield 540 may be comprised of thin ferrite material and shaped/configured in a way that causes magnetic field 545 generated by magnet 535 (or by array of magnets 250) to be directed in a forward or front facing direction, i.e., towards a direction of the stator 110. This enables increased intensity of magnetic field 545, which in turn, increases magnetic flux density in the stator 110 for generating electricity. Rear facing magnetic field 547 is reduced in comparison to magnetic field 545. A back side shape of ferrite shield 540 may be rounded (as shown) or rectangular. A rounded back may deliver improved performance.

Further, in the embodiment shown in FIG. 5A, power generated can be distributed via, e.g., a fault managed power transmitter 550 and fault managed power receiver 560 (perhaps up to 5 km away), and through a DC to AC inverter 570 to produce, e.g., 240 VAC for direct home use, or to supply to the electric grid. Such an inverter 570 could be similar to ones suitable for use in the solar power industry.

The term “Fault Managed Power” (FMP) as used herein refers to power (e.g., >100 W), high voltage (e.g., >56V) delivered on one or more wires or wire pairs in such a way to allow for the power over the one or more wires or wire pairs to be terminated upon detecting a fault condition on the wire that could be harmful to a human, for example. In one implementation, power and data may be transmitted together (in-band) on at least one wire pair. FMP may involve fault detection (e.g., fault detection (safety testing) at an initialization stage, and thereafter on an ongoing basis during power delivery. The power may be, but is not required to be, pulse power comprising high power pulses separated by off times, and fault detection may be performed during the off times. The power may be transmitted with communications (e.g., bi-directional communications) or without communications.

The term “pulse power” (also referred to as “pulsed power”) refers to power that is delivered in a sequence of pulses (alternating low direct current voltage state and high direct current voltage state) in which the voltage varies between a very small voltage (e.g., close to 0V, 3V) during a pulse-off interval and a larger voltage (e.g., >12V, >24V) during a pulse-on interval. High voltage pulse power (e.g., >56 VDC, >60 VDC, >300 VDC, ^{˜}108 VDC, ^{˜}380 VDC) may be transmitted from power sourcing equipment to a powered device for use in powering the powered device, as described, for example, in U.S. patent application Ser. No. 16/671,508 (“Initialization and Synchronization for Pulse Power in a Network System”), filed Nov. 1, 2019, which is incorporated herein by reference in its entirety. Pulse power transmission may be through cables, transmission lines, bus bars, backplanes, PCBs (Printed Circuit Boards), and power distribution systems, for example. It is to be understood that the power and voltage levels described herein are only examples and other levels may be used.

As noted above, safety testing (fault sensing) may be performed through a low voltage safety check between high voltage pulses in the pulse power system. Fault sensing may include, for example, line-to-line fault detection with low voltage sensing of the cable or components and line-to-ground fault detection with midpoint grounding. The time between high voltage pulses may be used, for example, for line-to-line resistance testing for faults and the pulse width may be proportional to DC (Direct Current) line-to-line voltage to provide touch-safe fault protection. The testing (fault detection, fault protection, fault sensing, touch-safe protection) may comprise auto-negotiation between power components. The high voltage DC pulse power may be used with a pulse-to-pulse decision for touch-safe line-to-line fault interrogation between pulses for personal safety.

In one or more embodiments, FMP may comprise pulse power transmitted in multiple phases in a multi-phase pulse power system with pulses offset from one another between wires or wire pairs to provide continuous power. One or more embodiments may, for example, use multi-phase pulse power to achieve less loss, with continuous uninterrupted power with overlapping phase pulses.

FMP may be converted into Power over Ethernet (POE) and used to power electrical components. In one or more embodiments, power may be supplied using Single Pair Ethernet (SPE) and may include data communications (e.g., 1-10GE (Gigabit Ethernet)). The power system may be configured for PoE (e.g., conventional PoE or PoE+ at a power level <100 watts (W), at a voltage level <57 volts (V), according to IEEE 802.3af, IEEE 802.3at, or IEEE 802.3bt), Power over Fiber (PoF), advanced power over data, FMP, or any other power over communications system in accordance with current or future standards, which may be used to pass electrical power along with data to allow a single cable to provide both data connectivity and electrical power to components (e.g., battery charging components, server data components, electric vehicle components). To be clear, FMP may involve pulse power or continuous non-interrupted power.

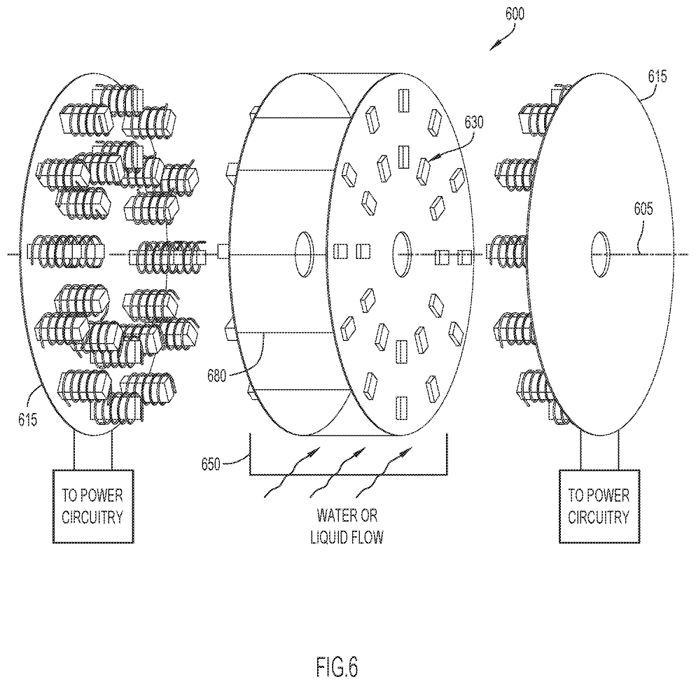

FIG. 6 shows another electric power generator 600 operating in conjunction with a water wheel, according to an example embodiment. In this embodiment, ferrite cores 120 are mounted in a circular configuration on, e.g., a circular base plate 615, that is stationary and supported by an axel 605. Magnets 630 are mounted on a wheel 680, which rotates on axel 605, in a corresponding circular configuration such that outwardly facing surfaces of the magnets 630 face exposed faces 127 of the ferrite cores as the magnets 630 are spun on the wheel 680 by liquid or water flow 650. Ferrite cores 120 may be grouped together in, e.g., groups of six, similarly to the rows of magnets in the array of magnets 250. In one embodiment, the diameter of the circular base plate 615 may be on the order of four feet. Such a system can output 400 VAC, which can be supplied to the circuit shown in FIG. 4, for example.

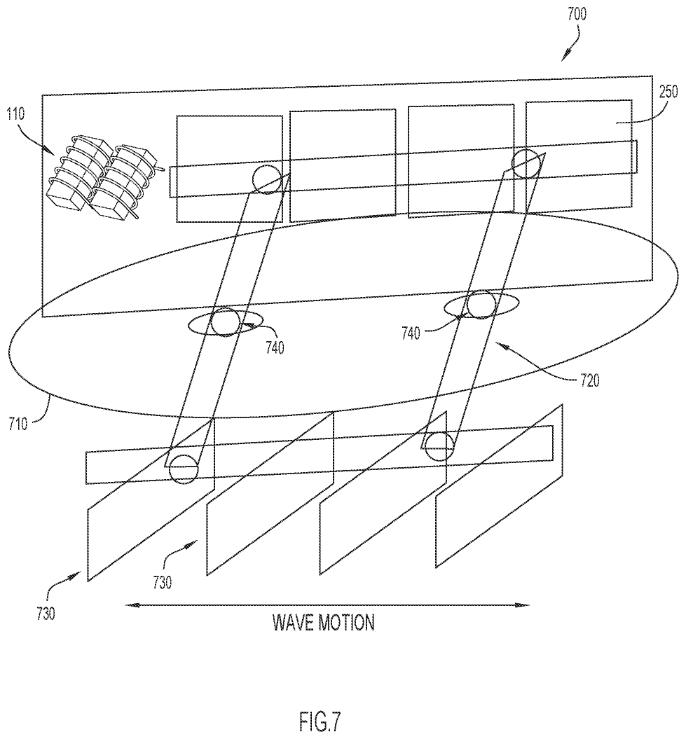

FIG. 7 shows an electric power generator 700 operating in conjunction with a wave activated outside power source, according to an example embodiment. In this embodiment, a float 710 is moored to, e.g., the ocean floor, and is configured to pivotally support arms 720 that are connected on one end to paddles 730 and on another end to one or more array of magnets 250. The arms pivot around pivot points 740 and, as waves move the paddles 730 back and forth, the arms 720, in turn, move the array of magnets 250 back and forth across stator 110 (not drawn to scale) comprising ferrites cores 120 wrapped with coils 150. The paddles 730 could also be mounted to a more secure structure such as a dock or pier.

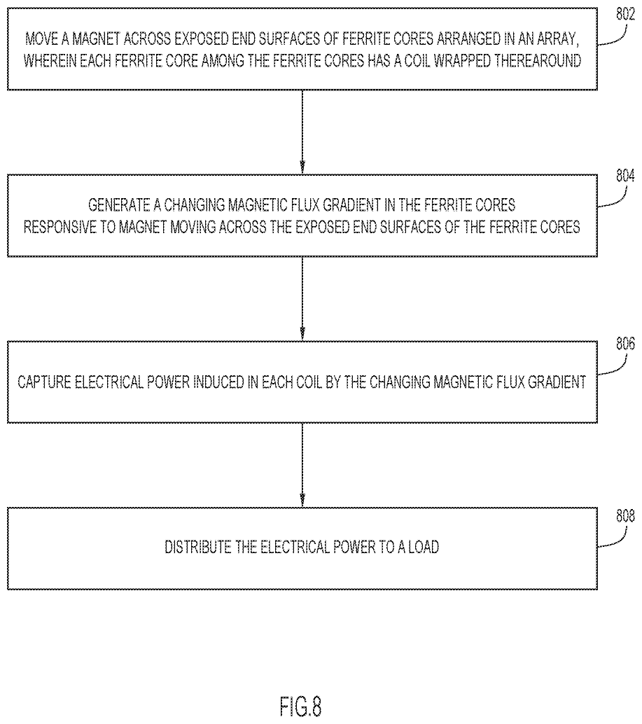

FIG. 8 is a flow chart showing a series of operation for generating power from the electric power generator, according to an example embodiment. At 802, a operation is configured to move a magnet across exposed end surfaces of ferrite cores arranged in an array, wherein each ferrite core among the ferrite cores has a coil wrapped therearound. At 804, an operation is configured to generate a changing magnetic flux gradient in the ferrite cores responsive to the magnet moving across the exposed end surfaces of the ferrite cores. At, 806, an operation is configured to capture electrical power induced in each coil by the changing magnetic flux gradient. And, at 808, an operation is configured to distribute the electrical power to a load.

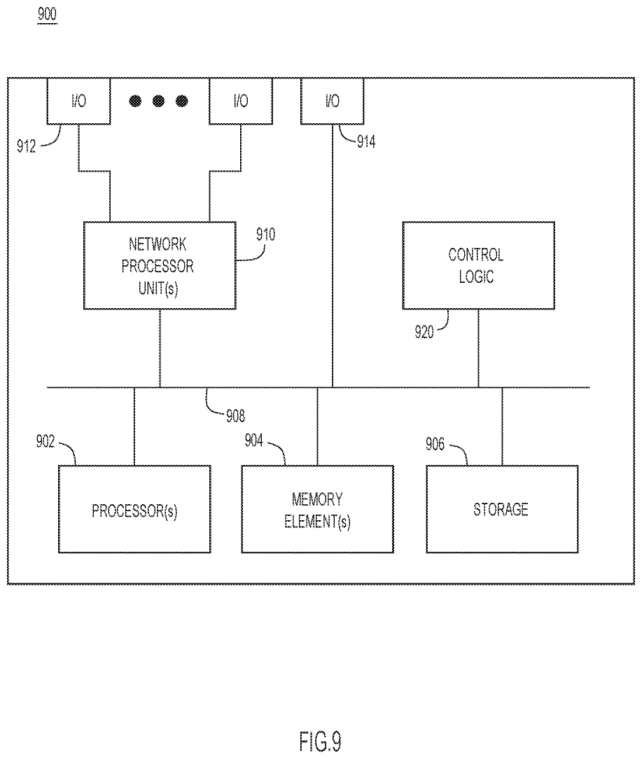

FIG. 9 is a block diagram of a computing device that may be configured to operate and/or control fault managed power, and perform the techniques described herein, according to an example embodiment. In various embodiments, a computing device, such as computing device 900 or any combination of computing devices 900, may be configured as any entity/entities as discussed for the techniques depicted in connection with FIGS. 1-8 in order to perform operations of the various techniques discussed herein.

In at least one embodiment, the computing device 900 may include one or more processor(s) 902, one or more memory element(s) 904, storage 906, a bus 908, one or more network processor unit(s) 910 interconnected with one or more network input/output (I/O) interface(s) 912, one or more I/O interface(s) 914, and control logic 920. In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa) or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 (wired and/or wireless) to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, any other I/O port(s), and/or antenna(s)/antenna array(s) now known or hereafter developed. Thus, the network processor unit(s) 910 and/or network I/O interface(s) 912 may include suitable interfaces for receiving, transmitting, and/or otherwise communicating data and/or information in a network environment.

I/O interface(s) 914 allow for input and output of data and/or information with other entities that may be connected to computing device 900. For example, I/O interface(s) 914 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of and ‘one or more of can be represented using the’ (s)′ nomenclature (e.g., one or more element(s)).

In sum, an apparatus includes a base plate, a plurality of ferrite cores arranged on the base plate in a geometric pattern, each ferrite core in the plurality of ferrite cores having a longitudinal axis that is normal to the base plate, at least one coil wound around each ferrite core in the plurality of ferrite cores, and an array of magnets arranged to pass over exposed end faces of each ferrite core in the plurality of ferrite cores.

In the apparatus, the base plate may be comprised of a ferrous material.

In the apparatus, the geometric pattern may include rows and columns.

In the apparatus, each ferrite core may include multiple overlapping coils.

In the apparatus, each ferrite core may include a protrusion at one end that couples to a corresponding opening in the base plate.

In the apparatus, the base plate may be square.

In the apparatus, the base plate may be circular.

In the apparatus, magnets in the array of magnets may be spaced to correspond to a spacing of the plurality of ferrite cores.

The apparatus may further include an electric power regulation and isolation circuit electrically connected to the at least one coil wound around each ferrite core in the plurality of ferrite cores.

In the apparatus, the array of magnets may be caused to move over the exposed end faces using at least one of a moving vehicle, wave energy, or liquid flow.

In another embodiment, an apparatus includes a ferrous base plate, ferrite cores arranged on the ferrous base plate, the ferrite cores having a longitudinal axis that is normal to the ferrous base plate, the ferrite cores having respective exposed end faces, at least one coil respectively wound around the ferrite cores, and an array of magnets arranged to pass over the exposed end faces.

In the apparatus, the ferrite cores may be arranged in rows and columns.

In the apparatus, the ferrite cores may include multiple overlapping coils.

In the apparatus, the ferrite cores may include a protrusion at one end that couples to a corresponding opening in the ferrous base plate.

In the apparatus, the ferrous base plate may be square.

In the apparatus, the ferrous base plate may be circular.

In the apparatus, magnets in the array of magnets may be spaced to correspond to a spacing of the ferrite cores.

In yet another embodiment, a method includes moving a magnet across exposed end surfaces of ferrite cores arranged in an array, wherein each ferrite core among the ferrite cores has a coil wrapped therearound, generating a changing magnetic flux gradient in the ferrite cores responsive to magnet moving across the exposed end surfaces of the ferrite cores, capturing electrical power induced in each coil by the changing magnetic flux gradient, and distributing the electrical power to a load.

In the method, the magnet may be part of an array of magnets.

The method may further include moving the magnet using at least one of a moving vehicle, wave energy, or liquid flow.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. An apparatus including:
a base plate;
a plurality of ferrite cores arranged on the base plate in a geometric pattern, each ferrite core in the plurality of ferrite cores having a longitudinal axis that is normal to the base plate;
at least one coil wound around each ferrite core in the plurality of ferrite cores; and
an array of magnets arranged to pass over exposed end faces of each ferrite core in the plurality of ferrite cores.

2. The apparatus of claim 1, wherein the base plate is comprised of a ferrous material.

3. The apparatus of claim 1, wherein the geometric pattern comprises rows and columns.

4. The apparatus of claim 1, wherein each ferrite core comprises multiple overlapping coils.

5. The apparatus of claim 1, wherein each ferrite core includes a protrusion at one end that couples to a corresponding opening in the base plate.

6. The apparatus of claim 1, wherein the base plate is square.

7. The apparatus of claim 1, wherein the base plate is circular.

8. The apparatus of claim 1, wherein magnets in the array of magnets are spaced to correspond to a spacing of the plurality of ferrite cores.

9. The apparatus of claim 1, further comprising an electric power regulation and isolation circuit electrically connected to the at least one coil wound around each ferrite core in the plurality of ferrite cores.

10. The apparatus of claim 1, wherein the array of magnets is caused to move over the exposed end faces using at least one of a moving vehicle, wave energy, or liquid flow.

11. An apparatus comprising:
a ferrous base plate;
ferrite cores arranged on the ferrous base plate, the ferrite cores having a longitudinal axis that is normal to the ferrous base plate;
the ferrite cores having respective exposed end faces;
at least one coil respectively wound around the ferrite cores; and
an array of magnets arranged to pass over the respective exposed end faces.

12. The apparatus of claim 11, wherein the ferrite cores are arranged in rows and columns.

13. The apparatus of claim 12, wherein the ferrite cores comprise multiple overlapping coils.

14. The apparatus of claim 11, wherein the ferrite cores include a protrusion at one end that couples to a corresponding opening in the ferrous base plate.

15. The apparatus of claim 11, wherein the ferrous base plate is square.

16. The apparatus of claim 11, wherein the ferrous base plate is circular.

17. The apparatus of claim 11, wherein magnets in the array of magnets are spaced to correspond to a spacing of the ferrite cores.

18. A method, comprising:
moving a magnet across exposed end surfaces of ferrite cores arranged in an array, wherein each ferrite core among the ferrite cores has a coil wrapped therearound;
generating a changing magnetic flux gradient in the ferrite cores responsive to magnet moving across the exposed end surfaces of the ferrite cores;
capturing electrical power induced in each coil by the changing magnetic flux gradient; and
distributing the electrical power to a load.

19. The method of claim 18, wherein the magnet is part of an array of magnets.

20. The method of claim 18, further comprising moving the magnet using at least one of a moving vehicle, wave energy, or liquid flow.
